(19) United States
(12) Patent Application Publication
(10) Pub. No.: US 2015/0332393 A1
(43) Pub. Date: Nov. 19, 2015

(54) Determining Option Strike Price Listing Range

(71) Applicant: Chicago Mercantile Exchange Inc., Chicago, IL (US)

(72) Inventors: John Kerpel, Chicago, IL (US); John Labuszewski, Westmont, IL (US); Frederick Sturm, Chicago, IL (US); Lori Aldinger, Naperville, IL (US); John Nyhoff, Darien, IL (US)

(73) Assignee: Chicago Mercantile Exchange Inc., Chicago, IL (US)

(21) Appl. No.: 14/280,212

(22) Filed: May 16, 2014

(51) Int. Cl. G06Q 40/04

(52) U.S. Cl. CPC G06Q 40/04

(57) ABSTRACT

A computer system may calculate an option strike price listing range using a volatility value. The volatility value may be determined based on market value data that corresponds to an optioned transaction type and that include multiple market values. Option class definition data may be generated and stored based on the calculated option strike price listing range.

### BACKGROUND

An option is an undertaking by which a first party has the right, but not the obligation, to require a second party to enter into an optioned transaction at some future time. That second party has an obligation to enter into that optioned transaction if the first party exercises its right. The first party may be called the “receiver,” “buyer,” “holder” or “bearer” of the option. The second party may be called the “grantor,” “seller” or “writer” of the option. An option grantor will often receive a payment in return for granting that option. Similarly, an option buyer often makes some payment in return for receiving the option.

Optioned transactions can take many forms. For example, an optioned transaction may be the sale of a financial instrument (e.g., a stock, a bond, a government-issued obligation), the sale of some quantity of a physical good (e.g., some agricultural or industrial commodity) or the sale of some other type of underlying subject matter. A holder of an option in this example may have the right to require the option grantor to sell (or buy) the underlying subject matter, at a predefined future time, at a predefined price. As another example, an optioned transaction may be the entry into a futures contract or some other type of subsequent agreement. A holder of an option in this example may have the right to require the option grantor to sell (or buy) a particular type of futures contract, at a predefined future time, at a predefined price. There are numerous other types of optionable transactions.

Options normally have certain terms. One of those terms, of course, specifies the optioned transaction. Another of those terms is the premium. The premium is the payment provided by an option buyer for a received option. Typically, the option buyer provides that payment, directly or indirectly, to the option seller as consideration for granting the option.

Another option term is the option type, i.e., whether the option is a “call” or a “put.” In a call option, the option holder normally has the rights of a buyer under the optioned transaction. Conversely, the grantor of a call option normally has the rights of a seller under the optioned transaction. For a call option in a futures contract, the optioned transaction is a futures contract as specified in the option. The call option holder has the right to buy that futures contract on specified terms at a specified time. As is commonly understood, a buyer of a futures contract takes a “long” position and agrees to pay the futures contract price in return for future delivery of the underlying subject matter of the futures contract. The grantor of a call option in a futures contract has the obligation (upon option exercise) to sell that futures contract on specified terms at a specified time. As is also commonly understood, a seller of a futures contract takes a “short” position and agrees to receive the futures contract price in return for delivering that underlying subject matter of the futures contract.

In a put option, the option holder normally has the rights of a seller under the optioned transaction. A put option grantor normally has the rights of a buyer under the optioned transaction. If the optioned transaction is a futures contract, a put option holder has the right to sell a specified futures contract on specified terms at a specified time. A grantor of a futures contract put option has the obligation (upon option exercise) to buy the specified futures contract on specified terms at a specified time.

Another option term is the exercise or “strike” price. The strike price may represent a price to be paid if the optioned transaction goes forward. For a futures contract call option, the strike price is the futures price at which the option holder receives a long futures position if the option is exercised. A grantor of a futures contract call option receives a short futures position at that strike price if the option is exercised. For a futures contract put option, the strike price is the futures price at which the option holder agrees to receive a short futures contract position if the option is exercised. A grantor of a futures contract put option agrees to receive a long futures position, at the strike price, if the option is exercised.

Options may be multilaterally traded through an exchange. For example, an exchange may define a particular kind of option based on the optioned transaction, the option type and other terms (e.g., expiration date, exercise style). Parties wishing to buy or sell that kind of option may then do so through negotiation of a premium. In particular, the exchange may receive buy orders from parties wishing to buy options, with each of those buy orders indicating a kind of option defined by the exchange and which those parties wish to receive. Each of those buy orders may further indicate the premium that the buy order submitter is willing to pay. The exchange may also receive orders from other parties wishing to sell options, with each of those sell orders indicating the exchange-defined kind of option and the premium that the sell order submitter is willing to accept. The exchange may then anonymously match buy orders against sell orders based on the premium amounts indicated in the orders.

An exchange may designate, or “list,” numerous classes of options that related to the same optioned transaction type. As but one example, an exchange may allow trading of options on wheat futures contracts designating delivery in December of a particular year. A first class of such options may designate a first strike price, a second class of such options may designate a second strike price, a third class of such options may designate a third strike price, etc. A party wishing to execute an option on a December delivery wheat futures contract at the second strike price could submit an order for an option conforming to the second class, which order might indicate the premium the party is willing to pay to receive the option. If another party submits an order for an option conforming to the second class and indicating that other party will accept the same premium in return for granting the option, the two orders might then be matched and an option executed.

Current systems list option classes within a fixed range above and below current market prices of the relevant type of optioned transaction. This practice is sometimes arbitrary. Moreover, setting an option strike price listing range in such a manner may not always cover an appropriate range of prospective market prices with a reasonable degree of probability

### SUMMARY

This Summary is provided to introduce a selection of concepts in a simplified form that are further described below in the Detailed Description. This Summary is not intended to identify key features or essential features of the invention.

In some embodiments, a computer system may access market value data. The market value data may correspond to an optioned transaction type and include multiple market values. Each of the market values may correspond to a value for an instance of the optioned transaction type at a different one of multiple times. The multiple times may be distributed throughout a first time period. The computer system may determine a volatility value based on the market values. The volatility value may quantify a change in the market values applicable to a second time period. The computer system may further calculate an option strike price listing range using the volatility value. The computer system may additionally store option class definition data that may define a plurality of option classes. Each of the option classes may correspond to the optioned transaction type and one of multiple strike prices. Each of the multiple strike prices may represent a different price in the option strike price listing range.

Embodiments include, without limitation, methods for processing data associated with options and/or option classes, computer systems configured to perform such methods and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2A-2H are block diagrams showing operations performed by an exchange computer system in connection with options and option classes according to some embodiments.

FIG. 3 shows an example of market value data according to some embodiments.

FIG. 4 is a flow chart showing steps performed in methods according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made.

Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

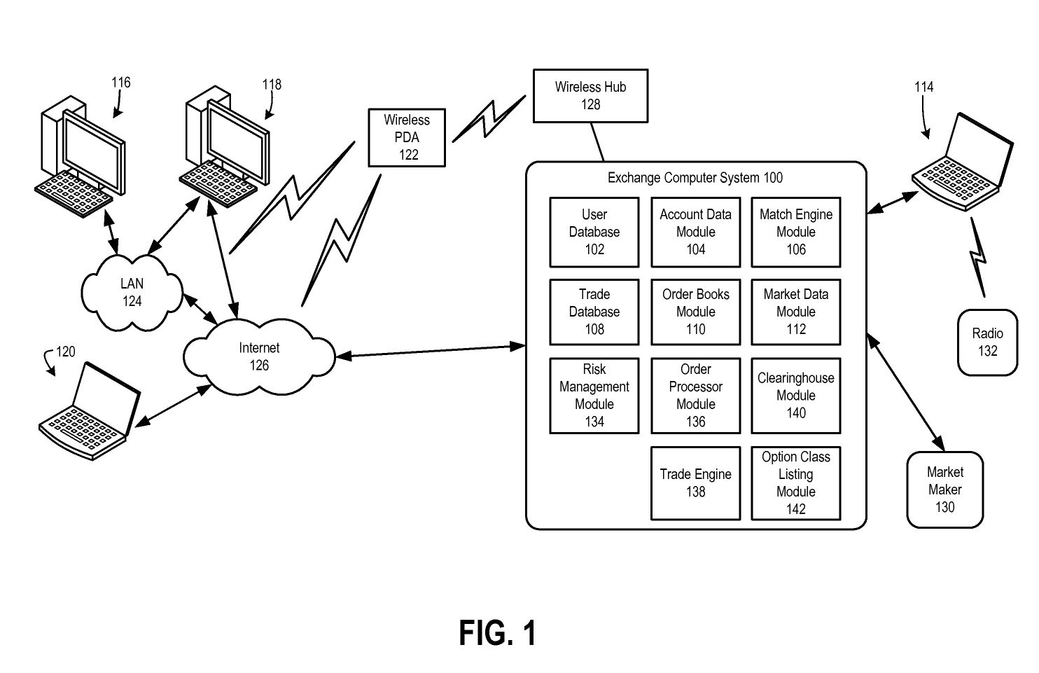

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with options and option classes.

Computer system 100 can be operated by a financial product exchange and configured to perform operations of the exchange for, e.g., trading and otherwise processing various financial products. Financial products of the exchange may include, without limitation, futures contracts, options on futures contracts, other types of options, and other types of derivative contracts. Financial products traded or otherwise processed by the exchange may also include over-the-counter (OTC) products such as OTC forwards, OTC options, OTC swaps, etc. Financial products traded through the exchange may also or alternatively include other types of financial interests, including without limitation stocks, bonds and or other securities (e.g., exchange traded funds), foreign currencies, and spot market trading of commodities. In at least some embodiments, and as explained in more detail below, financial products traded and/or otherwise processed through exchange computer system 100 include options such as those described herein and optioned transactions associated with such options.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100, including option class listing module 142, regarding trades of futures contracts, futures contracts options, and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise and/or may select option grantors to fulfill obligations of exercising option holders. Module 140 may also be configured to perform other clearinghouse operations. As a further example, module 140 may maintain margin data with regard to clearing members and/or trading customers. As part of such margin-related operations, module 140 may store and maintain data regarding the values of various options, futures contracts and other interests, determine mark-to-market and final settlement amounts, confirm receipt and/or payment of amounts due from margin accounts, confirm satisfaction of delivery and other final settlement obligations, etc.

Option class listing module 142 generates, stores and processes data regarding option class definitions. Various operations performed by option class listing module 142 in at least some embodiments are further described below. Operations associated with options and/or option classes may also and/or alternatively be performed by other modules of system 100.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations associated with options and/or option classes.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates and/or otherwise processes option-related data as described herein. In common parlance, the word “option” is sometimes used to describe individual option contracts as well as categories of option contracts. To avoid confusion, the following convention is thus used herein. “Option” refers to a contract that is created, or “executed,” when two parties have agreed to assume responsibilities of option receiver and option grantor. The parties may reach that agreement bilaterally or multilaterally through an exchange. “Option class” (or “class of options”) refers to a category of options for which some of the following terms are the same: optioned transaction, option type, option strike price, option exercise style, and option expiration date. “Option superclass” (or “superclass of options”) refers to a group of option classes that are similar to one another, but where a term may have a different value for each class in the super class. For example, a superclass could include numerous classes of wheat futures contract options. Each class in the superclass could specify a different strike price but otherwise be the same as other classes in the subclass.

Option execution is distinct from option exercise. Option execution refers to the creation of an option contract. Option exercise refers to the exercise of rights under that executed option by the option holder.

Throughout this description, “optioned transaction type” is similarly distinguished from “optioned transaction.” “Optioned transaction” refers to a transaction that may take place if a specific option is exercised. “Optioned transaction type” refers to a category of optioned transactions associated with an option class. For example, an option class definition may specify June delivery natural gas futures contracts as the optioned transaction type. Every option conforming to that option class may have a June delivery natural gas futures contract as its optioned transaction.

Computer system 100 may generate and store option class definition data for each of multiple classes of options tradable through an exchange that operates computer system 100. For each class of options, the option class definition data may include multiple parameters. Each of those parameters may correspond to and define a value for a term of every option conforming to the defined option class.

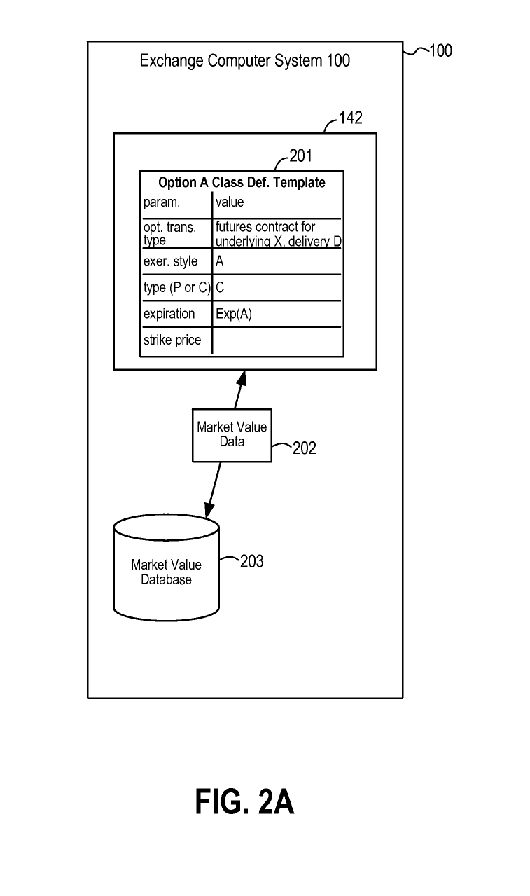

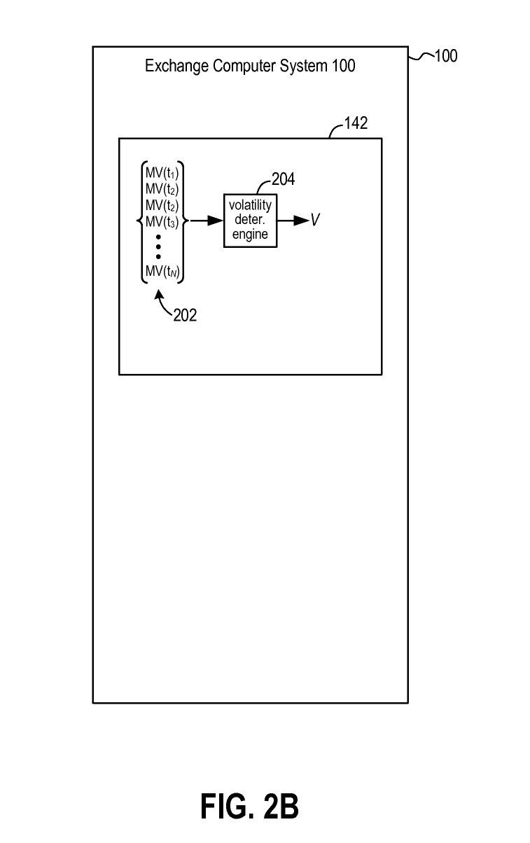

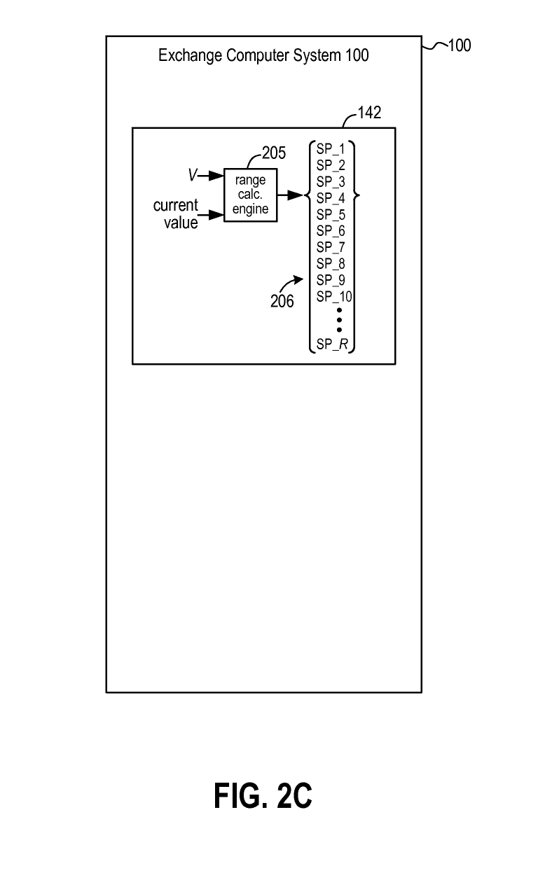

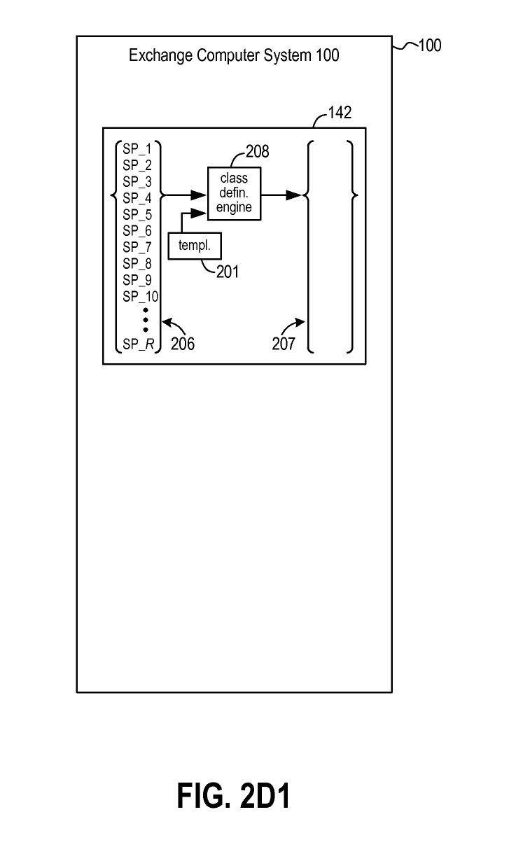

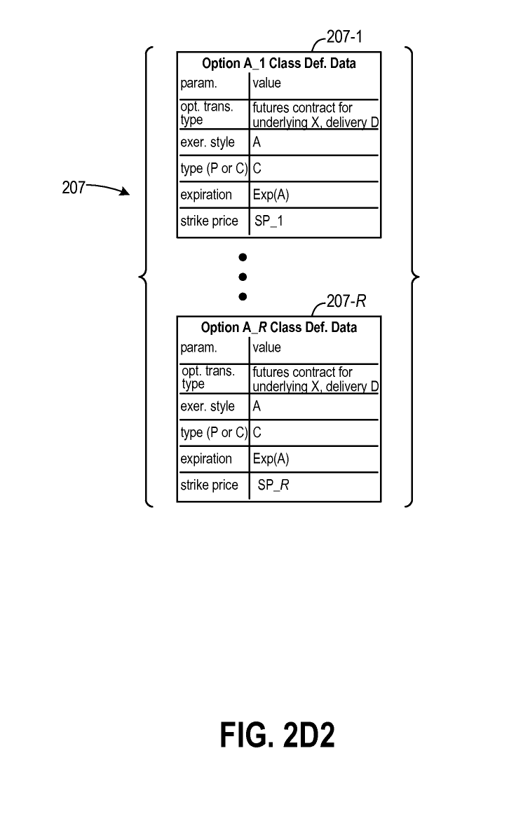

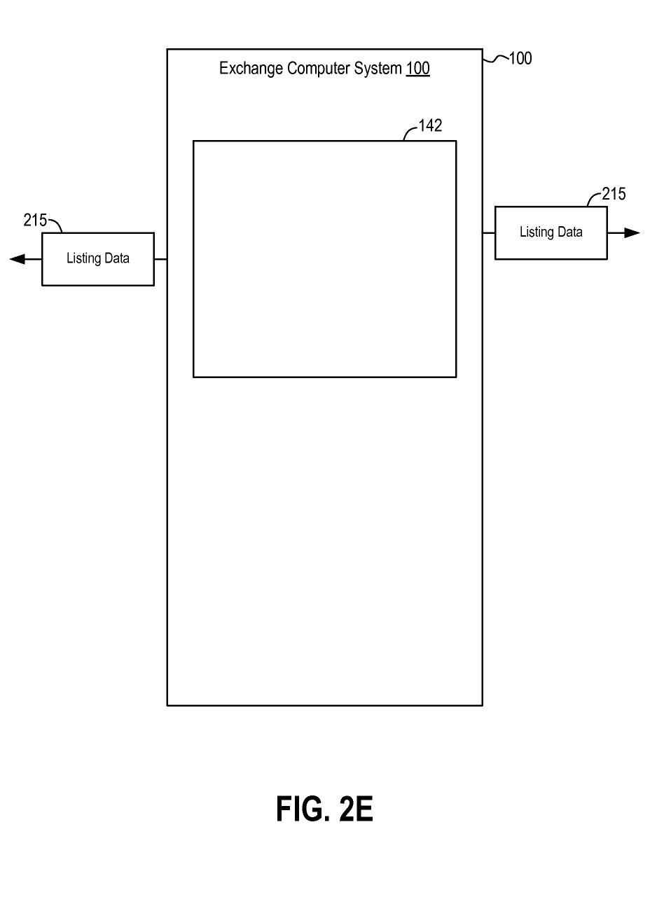

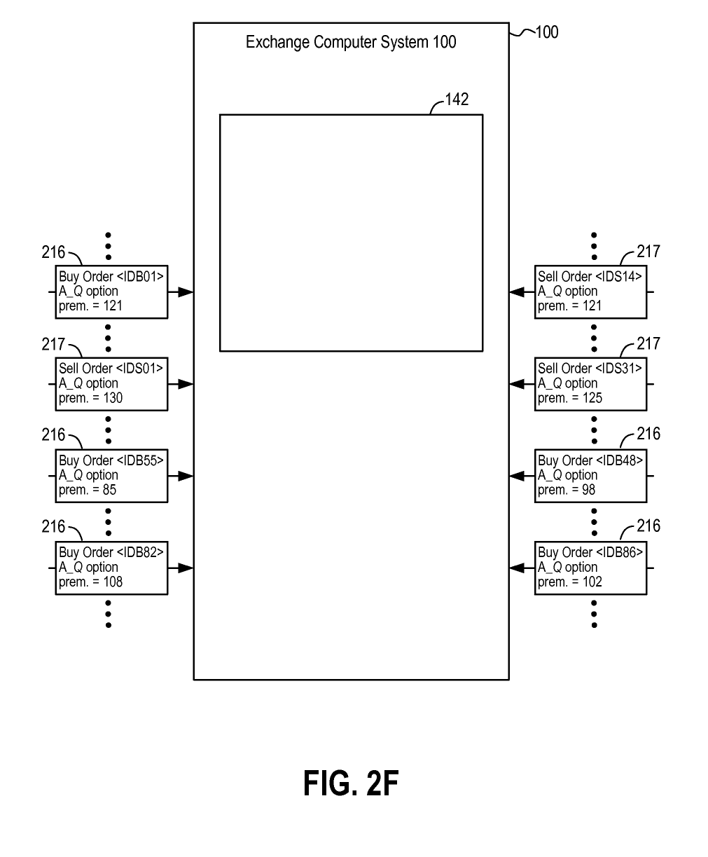

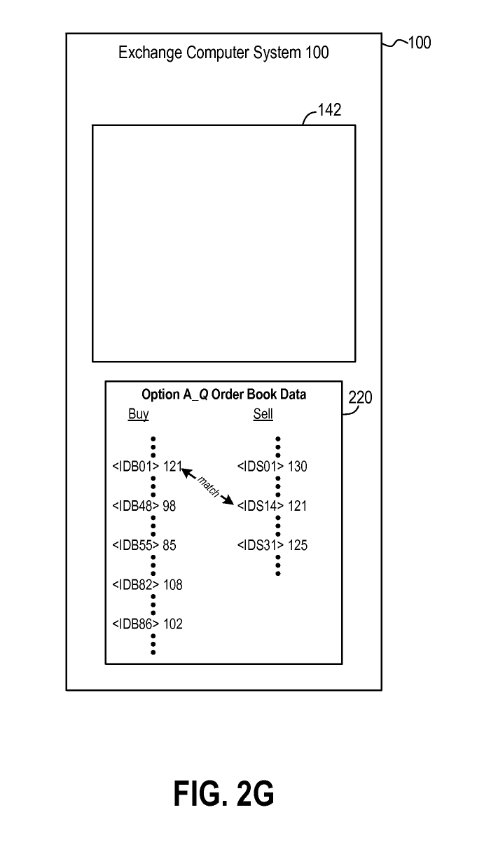

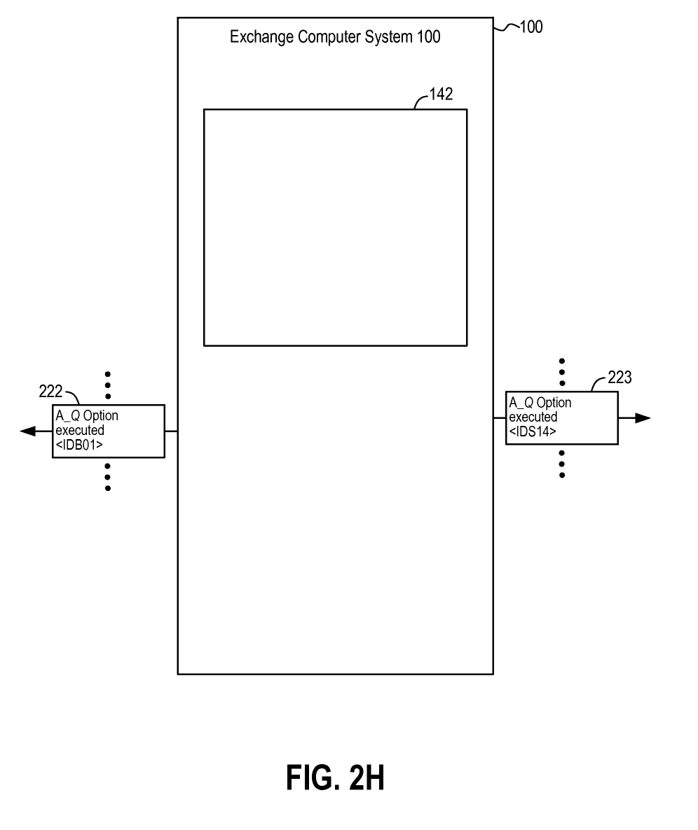

FIGS. 2A through 2H are block diagrams showing operations performed by computer system 100 according to at least some embodiments. Although the below description may refer to performance of operations by specific modules of computer system 100, in other embodiments one or more of such operations may be performed by different modules and/or by a computer system that is not an exchange computer system.

To simplify explanation, the operations of FIGS. 2A through 2H are described using a single hypothetical superclass of options. In particular, a hypothetical “A option” superclass includes R option classes A_{—}1, A_{—}2, A_{—}3, . . . A_R. A generic member of the A option superclass will be referred to as an “A_” option class. For each of the classes in the A option superclass, computer system 100 may generate and store class definition data that define terms applicable to all options conforming to that class.

FIG. 2A shows a data template 201 for an A_option class definition. Template 201 may be stored in module 142 or elsewhere by computer system 100. The terms defined by an A_option class definition include optioned transaction type, exercise style (e.g., American or European), option type (i.e., put or call), expiration and strike price. Most of these terms may be the same for all A_option classes. For example, template 201 shows that the optioned transaction type for all A_option classes is a type of futures contract that requires delivery of a specified underlying (“X”) and on a specified delivery date (“D”). The terms “X” and “D” are used in the present example for convenience, but are intended represent an actual underlying and an actual date that would be constant for optioned transactions of all options conforming to a particular option class. The “X” underlying could be a commodity (e.g., an agricultural, energy, metal or other type of commodity), a government-issued security (e.g., a United States Treasury Bill or Note), a non-government security (e.g., a stock of a corporation), a currency, a market index, or some other subject matter. The optioned transaction type definition could be, e.g., a pointer to memory location elsewhere in system 100 that contains a definition of a type of futures contract traded through computer system 100.

As also seen in FIG. 2A, template 201 includes data specifying values of other terms that apply to all A_option classes. In particular, all A_option classes define the same exercise style (“A”, for American), the same option type (“C”, for call) and the same expiration date (“Exp(A)”). As indicated by the blank field for the strike price term, however, template 201 does not define a strike price for each A class definition. Instead, the strike price term for each A_option class may be different from the strike price terms of other A_option classes. In other words, each A_option class may correspond to a different strike price.

In order to finalize class definition data for A_option classes, system 100 may determine a range of strike prices to which the A_option classes will respectively correspond. As further shown in FIG. 2A, computer system 100 accesses market value data 202 that will be used to determine that strike price range. The accessed market value data 202 may be retrieved from a market value database 203. Although shown as part of computer system 100 in the present example, database 203 could also or alternatively be distinct from computer system 100. In some embodiments, computer system 100 may receive market value data from multiple databases or other sources and/or in multiple batches or other groupings of data.

Market value data 202 includes data that corresponds to an optioned transaction type and that includes multiple market values that correspond to values of instances of the optioned transaction type at different times. Those times may be distributed over a previous time period (e.g., one or more months, one or more years, etc.). For example, the market value data may include, for each trading day in the previous year, the trading price of an instance of the optioned transaction type at the close of that trading day. In the present example, market value data 202 includes closing trade prices for D-delivery X futures contracts for each of N previous trading days. In some embodiments, N may represent the number of trading days in the preceding year (e.g., N=252), although other time periods (and corresponding values of N) could be used. As discussed below, in some embodiments data corresponding to instances of an optioned transaction type may be data providing values of analogous financial interests.

FIG. 2B shows operations performed by computer system 100 after accessing market value data 202. That data is represented in FIG. 2B as an array of values MV. Each array element represents a market value for a D-delivery X futures contract at one of N times t₁ through t_{N}. Using a volatility determination engine 204, module 142 calculates a volatility value V based on market value data 202. Volatility V quantifies a change in market values applicable to a second time period. That second time period may be the same as or different from the first time period over which the data elements in market value data 202 extend. Volatility determination engine 204 may be software executed by or as part of module 142.

In some embodiments, volatility determination engine 204 determines a volatility based on a standard deviation of market values as applied to the second time period. For example, in some embodiments engine 204 determines volatility V according to Equation 1.

$$V = \sqrt{d * {\sum }_{t = 2}^{t = N} \frac{{[ ln ( {P}_{t} / {P}_{t - 1} ) ]}^{2}}{N}} \qquad Equation 1$$

In Equation 1, the variable d represents an annualization factor equal to the number of days in a trading year, typically 252. The variable t is a time during the first time period over which the market value data elements are distributed. The variable N is the total number of market value data elements. The variables Pₜ and Pₜ₋₁ are the market values corresponding to times t and time t−1, respectively. In the current example, and assuming d=N, Equation 1 becomes

$$\begin{matrix}V = \sqrt{N * [ \frac{{[ ln ( {P}_{2} / {P}_{1} ) ]}^{2}}{N} + \frac{{[ ln ( {P}_{3} / {P}_{2} ) ]}^{2}}{N} + … + \frac{{[ ln ( {P}_{N} / {P}_{N - 1} ) ]}^{2}}{N} ]} \\ = \sqrt{[ {[ ln ( {P}_{2} / {P}_{1} ) ]}^{2} + {[ ln ( {P}_{3} / {P}_{2} ) ]}^{2} + … + {[ ln ( {P}_{N} / {P}_{N - 1} ) ]}^{2} ]}\end{matrix}$$

A volatility V calculated according to Equation 1 would quantify a change in market values applicable to a trading year. In some embodiments, a volatility V may be scaled. For example, it may be desirable for a strike price range to be based on a shorter time period (e.g., one half year, one quarter year). In such a case, a volatility V calculated with Equation 1 can be scaled by \sqrt{(d′/d)}, where d′ is the number of trading days in a shorter time period of interest, so as to quantify a change in market values applicable to that shorter time period.

In other embodiments, volatility determination engine 204 may calculate volatility in a different manner. In some embodiments, for example, engine 204 may calculate V using a stochastic volatility model. Examples of stochastic volatility models include, without limitation, any of the following: a generalized autoregressive conditional heteroskedasticity (GARCH) model, a Heston model, a constant elasticity of variance (CEV) model, a stochastic alpha, beta, rho (SABR) model, a 3/2 model or a Chen model.

FIG. 2C shows operations performed by computer system 100 after determining volatility value V. In particular, module 142 uses a range calculation engine 205 to calculate a strike price listing range 206 based on volatility value V. As with volatility determination engine 204, range calculation engine 205 may be software executed by or as part of module 142. In some embodiments, engine 205 calculates a range of strike prices by first obtaining a two-tail Z value corresponding to a desired predetermined percentile. A two-tail Z value is known probability parameter. Tables mapping two-tail Z values to percentiles are well known. The predetermined percentile used by engine 205 can be chosen based on a desired degree of confidence that the calculated strike price range will cover an expected range of optioned transaction market prices over a forthcoming second time period. After obtaining the Z value corresponding to the predetermined percentile, that Z value, the volatility value V and the current market value for instances of the optioned transaction type are multiplied. The product may then be used to set upper and lower bounds of the strike price listing range relative to the current market market value. The current market value for instances of the optioned transaction type could be, e.g., a current trading price for such instances.

The following example illustrates this procedure. In this example, the predetermined percentile is 95%, V equals 0.16 and the current market value of an instance of the optioned transaction type is $1800. The two-tail Z value corresponding to the 95th percentile is approximately 1.96. Multiplying these values (1.96*16%*011800) yields $564.48. The lower and upper bounds on the strike price listing range are then respectively set at $1800-$564.48 (or $1235.52) and $1800+$564.48 (or $2364.48). If it is further assumed that the minimum tick size at which instances of the optioned transaction type are traded is $1.25, then each of the upper and lower bounds may be rounded to an even multiple of the minimum tick size (e.g., to $1235.00 and to $2365.00). In this example, the strike price listing range would thus be {SP_{—}1=$1235.00, SP_{—}2=$1236.25, . . . SP_{—}453=$1800, . . . SP_R=$2365}.

FIG. 2D1 shows operations performed by computer system 100 after calculating an option strike price listing range 206. As part of the operations shown in FIG. 2D1, a class definition engine 208 (which may also be software executed by or as a part of module 142) generates and stores option class definition data 207. Class definition data 207 includes class definitions for all option classes A_1 through A_R in the A option superclass. For each A_option class, the definition data defines a strike price term that is different from the strike price terms of other A_option classes and that corresponds to one of the prices in strike price listing range 206. In some embodiments, engine 208 generates and stores class definition data by storing multiple copies of template 201, with each stored copy including a different one of the strike prices in range 206.

FIG. 2D2 shows additional details of class definition data 207. Class definition data sets 207-1 through 207-R respectively correspond to option classes A_1 through A_R. For each of data sets 207-1 through 207-R, the values for the optioned transaction, exercise style, option type and expiration parameters are the same as those in template 201. However, each of data sets 207-1 through 207-R includes a different value for the strike price parameter selected from strike price listing range 206.

FIG. 2E shows operations performed by computer system 100 after generating and storing class definition data 207. In particular, computer system 100 transmits listing data 215 that identifies option classes A_1 through A_R to interested parties and thereby informs those parties that A_1 options, A_2 options, . . . and A_R options can be traded through computer system 100. Listing data 215 can be transmitted in various manners. In some embodiments, for example, listing data 215 may be transmitted in response to requests transmitted to a web page.

FIG. 2F shows operations performed by computer system 100 in connection with receipt of orders for options conforming to the option A_Q class definition. “A_Q” is an arbitrary one of classes A_1 through A_R (i.e., Q is an integer between 1 and R) selected for purposes of illustration. Computer system 100 may also receive orders for options conforming to other A_option classes. One or more parties may submit data 216 indicating a buy order for one or more A_Q options. Each of those orders may indicate the class of option that the order submitter wishes to buy. In the current example, each buy order data block 216 indicates that the order submitter is available to receive an option in conformance with the option A_Q class definition. Each of the buy orders may further indicate a value for a premium that the order submitter will pay. One or more parties may also submit data 217 indicating a sell order for one or more A_Q options. Each of those orders may indicate the class of option that the order submitter wishes to sell and a value for a premium that the order submitter will accept. In the current example, each sell order data block 217 indicates that the order submitter is available to grant an option in conformance with the A_Q option class definition data and a value for a premium that the order submitter will accept. The vertical ellipses in FIG. 2F indicate that additional buy order data 216 and sell order data 217 may also be received. As also shown in FIG. 2F, each of the buy order data 216 and sell order 217 may include a unique identifier. For convenience, such identifiers are in the form “<IDB_>” and “<IDS_>.”

FIG. 2G shows operations performed by computer system 100 in connection with matching of orders for options conforming to A_Q option class definition data. In particular, computer system 100 identifies buy orders and sell orders that match based on premium values. In the current example, computer system 100 has stored A_Q option order book data 220 corresponding to the received buy order data 216 and sell order data 217 shown in FIG. 2F. Within data 220, computer system 100 identifies a pair of buy and sell orders that match based on an indicated premium value of 121. Specifically, buy order <IDB01> is matched with sell order <IDS14>. In some embodiments, order data is stored by order books module 110 and matching may be performed by match engine module 106. The vertical ellipses in FIG. 2G indicate that order book data 220 may include additional buy order data and additional sell order data, some or all of which may be matched. Computer system 100 may perform matching in various ways. In some embodiments, for example, computer system 100 could match orders using a first-in first-out algorithm. Other known matching algorithms could be used.

FIG. 2H shows operations performed by computer system 100 in connection with executed A_Q options. In particular, computer system 100 transmits data indicating execution of A_Q options corresponding to matched buy and sell orders. In the current example, computer system 100 transmits data 222 to the submitter of buy order <IDB01> indicating execution of an A_Q option corresponding to that buy order and data 223 to the submitter of sell order <IDS14> indicating execution of an A_Q option corresponding to that sell order. The vertical ellipses in FIG. 2H indicate that computer system 100 may also transmit other data indicating execution of additional options. Although not shown in FIG. 2H, computer system 100 may store data (e.g., in clearinghouse module 140) indicating the executed A_Q options and the parties to those executed A_Q options. Once executed, A_Q options may be exercised, traded or otherwise processed in a conventional manner.

Although FIGS. 2A through 2H show operations performed in connection with a single superclass of options, computer system 100 could simultaneously perform similar operations in connection with numerous other superclasses of options. Those superclasses may correspond to widely differing types of optioned transaction types. As but one example, those optioned transaction types can be futures contracts. The underlying subject matter for such a futures contract may be a commodity (e.g., an agricultural, energy, metal or other commodity), an interest rate, a foreign currency, an economic index, a sovereign debt instrument or other subject matter. As but another example, those optioned transaction types could also include (or consist of) sales of securities (e.g., stocks, bonds or exchange traded funds). As to each of multiple option superclasses, computer system 100 may simultaneously perform operations similar to those of FIGS. 2F-2H in connection with options conforming to numerous classes in the superclass.

As explained above, a strike price listing range can be determined based on market value data that includes values for instances of an optioned transaction type at multiple times in the past. In the example of FIGS. 2A-2H, market value data 202 took the form of previous closing prices for instances of the optioned transaction type (D-delivery X futures contracts). In some embodiments, however, other types of market value data can be used. Such other data may still correspond to values for instances of the optioned transaction type, but may represent values for one or more analogous economic interests.

For some types of optioned transactions, trading in instances of those optioned transaction types may vary widely over time. For example, there may be a high volume of such trading during time periods near maturity of the optioned transaction type, but trading volume may decrease significantly for periods further from maturity. However, it may be desirable to use data that extends over a relatively long time period when determining a volatility value V.

The following provides one example of such a circumstance. In this example, the optioned transaction type is a futures contract for underlying subject matter Y deliverable in March 2017. A strike price listing range is being calculated on Jan. 16, 2017, for options in March 2017 deliverable Y futures. In addition to contracts having March 2017 maturity, an exchange also permits trading of Y futures contracts maturing in other months. Regardless of the month in which instances of a Y futures contract type may mature, however, Y futures trading volume drops off substantially for contracts with longer maturity dates (e.g., there may be little or no trading for March 2017 maturing Y futures prior to September 2016). Determining volatility V for Y futures contracts maturing in two months based on trade data for Y futures contracts having significantly shorter or longer times to maturity may thus be inappropriate.

Accordingly, Y futures contracts maturing in months other than March 2017 can be utilized as analogous economic interests. Instead of accessing market value data that only includes values for March 2017 deliverable Y futures contracts, computer system 100 may access data, for each of multiple sample times in the year preceding Jan. 16, 2017, indicative of trade prices for Y futures contracts maturing within a 2-3 month maturity window relative to each sample time.

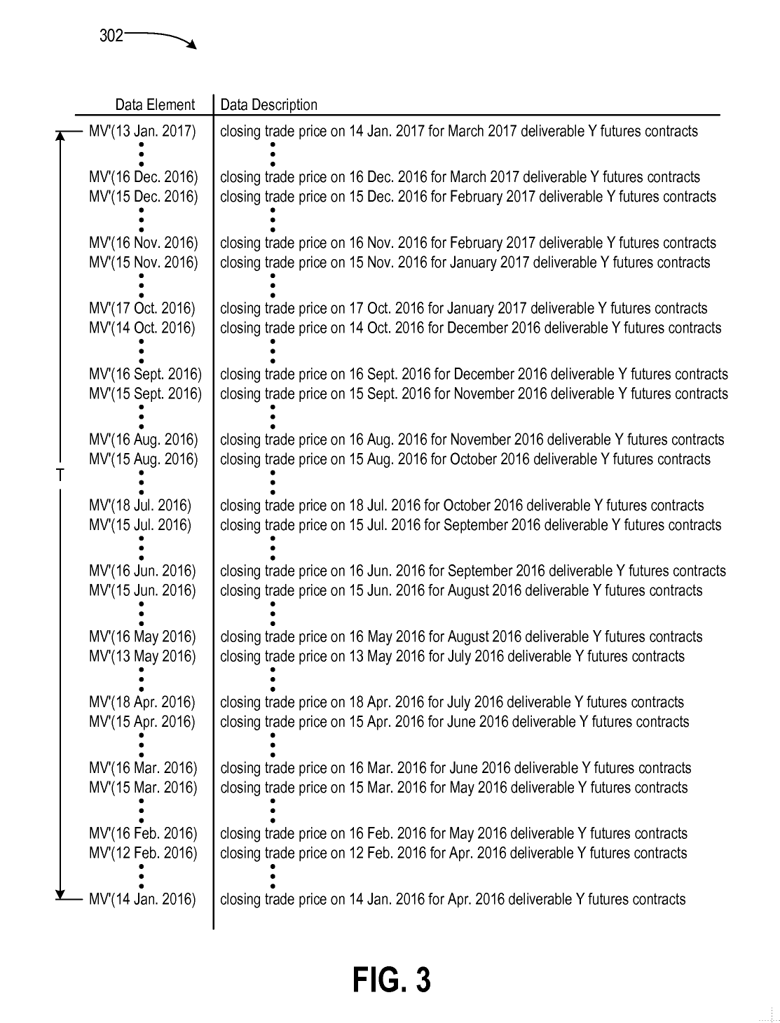

FIG. 3 shows market value data 302 according to this example. Although FIG. 3 shows market value data 302 in tabular form to assist explanation, data 302 could be formatted in some other manner. Similar to market value data 202 described above, data 302 includes multiple data elements MV′( ). Elements MV′( ) represent values, at each of multiple different sampling times distributed throughout a sampling period T, corresponding to values for March 2017 delivery Y futures contracts approximately two months prior to maturity. For one portion of period T, those corresponding values are values for March 2017 delivery Y futures contracts. For other portions of period T, those values are values for analogous financial interests different from March 2017 delivery Y futures contracts. In this example, the analogous financial interests are Y futures contracts with maturities other than March 2017, but that are within a 2-3 month remaining maturity window relative to individual sampling times.

As shown in FIG. 3, the MV′ (13 Jan. 2017) data element in the first row corresponds to the trading day (a Friday) immediately prior to Jan. 16, 2017 (a Monday). Data element MV′ (13 Jan. 2017) represents the closing price for March 2017 deliverable Y futures on Jan. 13, 2017. For each trading day from Jan. 12, 2017, through Dec. 16, 2016, the corresponding data element MV′ represents the closing price for March 2017 deliverable Y futures on that trading day. For Dec. 15, 2016 and previous trading days through Nov. 16, 2016, the corresponding data element MV′ represents the closing price for February 2017 deliverable Y futures on that trading day. A similar pattern then follows for previous trading days through Jan. 14, 2016.

FIG. 3 merely represents one example of data that can be used for calculating an option strike price listing range. In some embodiments, the sampling period T may be longer or shorter. The maturity window of analogous financial interests and/or the duration of the portions or sampling period T devoted to each analogous financial interest may also vary. Analogous financial interests are not limited to futures contracts having the same underlying but maturing on different dates. As but one example, a financial interest analogous to a D1-deliverable A futures contract might be a D2-deliverable B futures contracts, where D1 and D2 might be different dates and where A and B might be different underlying subject matters that may have historically similar trading patterns and values. In some embodiments, the current market value used when calculating a strike price listing range (e.g., by range calculation engine 205) may be a current market value of an analogous financial interest.

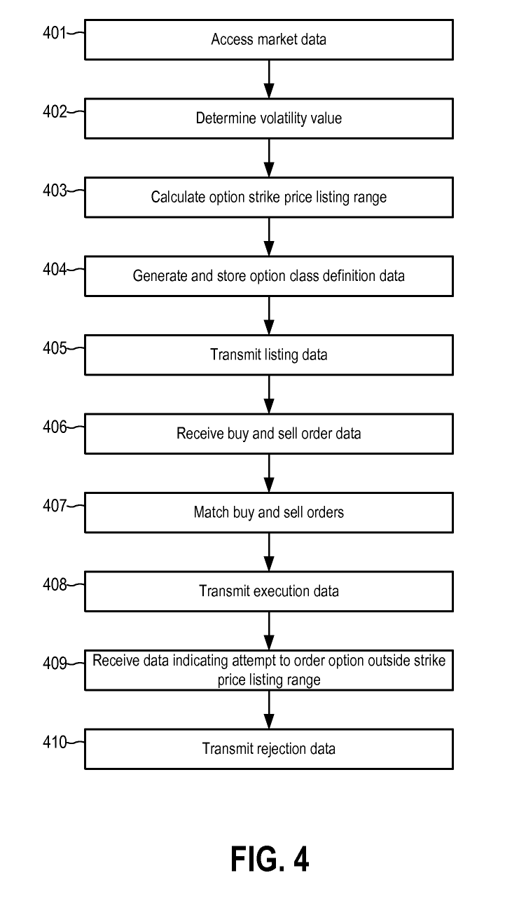

FIG. 4 is a flow chart showing operations performed in methods according to some embodiments. The flow chart of FIG. 4 encompasses various operations described in connection with FIGS. 2A through 2H, as well as operations performed in connection with other embodiments. In some embodiments, the operations of FIG. 4 are performed by exchange computer system 100. In other embodiments, the operations of FIG. 4 may be carried out by another type of computer system.

In step 401, computer system 100 accesses market value data. The accessed market value data may correspond to an optioned transaction type and may include multiple market values. Each of those market values may correspond to a value for an instance of the optioned transaction type at a different one of multiple times. The multiple times are distributed throughout a first time period. In some embodiments, and as indicated above in connection with FIG. 3, a market value corresponding to a value of an instance of the optioned transaction type may be a market value of an analogous financial interest.

In step 402, computer system 100 may determine a volatility value based on the market values accessed in step 401. The volatility value may quantify a change in the market values applicable to a second time period. In step 403, computer system 100 may calculate an option strike price listing range using the volatility value determined in step 402.

In step 404, computer system 100 may generate and store option class definition data. The option class definition data may define a plurality of option classes. Each of the option classes may correspond to the optioned transaction type and to one of multiple strike prices. Each of those strike prices may be a different price in the option strike price listing range calculated in step 403. In step 405 computer system 100 may transmit listing data identifying the option classes.

In step 406, computer system 100 may receive data corresponding to buy orders and sell orders for options corresponding to one of the option classes. In step 407, computer system 100 may match one or more of the received buy orders and one or more of the received sell orders. In step 408, computer system 100 may transmit data indicating execution of options corresponding to the matched buy orders and sell orders.

In step 409, computer system 100 may receive data indicating an attempt to place an order for an option corresponding to the optioned transaction type but to a strike price outside of the option strike price listing range calculated in step 403. In step 410, computer system 100 may transmit data indicating a rejection of the attempted order of step 409. The rejection may take the form of a notification indicating a party is attempting to place an order for an option that is not defined and/or not recognized by computer system 100.

Various steps in FIG. 4 can be performed in different orders. For example, the steps 409 and 410 could occur prior to or concurrently with steps 406 to 408. Various steps in FIG. 4 may also be performed repeatedly. For example, computer system 100 may perform steps 401 through 405 at an initial time. Computer system 100 may then continuously receive orders (step 406), match orders (step 407) and transmit execution data (step 408) until a subsequent time at which steps 401 through 405 are repeated and a new option strike price listing range is calculated and the option classes are redefined based on that new option strike price listing range.

Computer system 100 may separately perform the operations of FIG. 4 with regard to each of numerous different option superclasses. For each option superclass, the time periods between redefinition of option classes (e.g., time periods between performing steps 401-405 and then performing steps 401-405 again) may vary.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
accessing market value data by a computer system, wherein (i) the market value data corresponds to an optioned transaction type and includes multiple market values, (ii) each of the market values corresponds to a value for an instance of the optioned transaction type at a different one of multiple times, and (iii) the multiple times are distributed throughout a first time period;
determining a volatility value by the computer system and based on the market values, wherein the volatility value quantifies a change in the market values applicable to a second time period;
calculating an option strike price listing range by the computer system using the volatility value; and
storing option class definition data by the computer system, wherein (i) the option class definition data defines a plurality of option classes, (ii) each of the option classes corresponds to the optioned transaction type and one of multiple strike prices, and (iii) each of the strike prices is a different price in the option strike price listing range.

2. The method of claim 1, further comprising transmitting, by the computer system, data identifying the option classes.

3. The method of claim 1, further comprising:
receiving, by the computer system, order data corresponding to buy orders and sell orders for options corresponding to one of the option classes;
matching, by the computer system, buy orders to sell orders; and
transmitting, by the computer system, data indicating execution of options corresponding to the matched buy orders and sell orders.

4. The method of claim 1, wherein determining a volatility comprises determining a standard deviation applied to the second time period.

5. The method of claim 1, wherein determining a volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N}}$$
and wherein d is an annualization factor representing a number of days in a trading year, t is a time during the first time period, N is the total number of market values, Pₜ is the market value corresponding to time t, and Pₜ₋₁ is the market value corresponding to time t−1.

6. The method of claim 1, wherein determining a volatility comprises determining a volatility according to a stochastic volatility model.

7. The method of claim 6, wherein the stochastic volatility model is one of generalized autoregressive conditional heteroskedasticity model, a Heston model, a constant elasticity of variance model, a stochastic alpha, beta, rho model, a 3/2 model or a Chen model.

8. The method of claim 1, wherein at least a portion of the market values are values of analogous financial interests, each of the analogous financial interests being different from an instance of the optioned transaction type.

9. One or more non-transitory computer-readable media storing computer executable instructions that, when executed, cause a computer system to perform operations that include:
accessing market value data, wherein (i) the market value data corresponds to an optioned transaction type and includes multiple market values, (ii) each of the market values corresponds to a value for an instance of the optioned transaction type at a different one of multiple times, and (iii) the multiple times are distributed throughout a first time period;
determining a volatility value based on the market values, wherein the volatility value quantifies a change in the market values applicable to a second time period;
calculating an option strike price listing range using the volatility value; and
storing option class definition data, wherein (i) the option class definition data defines a plurality of option classes, (ii) each of the option classes corresponds to the optioned transaction type and one of multiple strike prices, and (iii) each of the strike prices is a different price in the option strike price listing range.

10. The one or more non-transitory computer-readable media of claim 9, wherein the stored instructions further comprise instructions that, when executed, cause the computer system to perform operations that include transmitting data identifying the option classes.

11. The one or more non-transitory computer-readable media of claim 9, wherein the stored instructions further comprise instructions that, when executed, cause the computer system to perform operations that include;
receiving order data corresponding to buy orders and sell orders for options corresponding to one of the option classes;
matching buy orders to sell orders; and
transmitting data indicating execution of options corresponding to the matched buy orders and sell orders.

12. The one or more non-transitory computer-readable media of claim 9, wherein determining a volatility comprises determining a standard deviation applied to the second time period.

13. The one or more non-transitory computer-readable media of claim 9, wherein determining a volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N}}$$
and wherein d is an annualization factor representing a number of days in a trading year, t is a time during the first time period, N is the total number of market values, Pₜ is the market value corresponding to time t, and Pₜ₋₁ is the market value corresponding to time t−1.

14. The one or more non-transitory computer-readable media of claim 9, wherein determining a volatility comprises determining a volatility according to a stochastic volatility model.

15. The one or more non-transitory computer-readable media of claim 14, wherein the stochastic volatility model is one of generalized autoregressive conditional heteroskedasticity model, a Heston model, a constant elasticity of variance model, a stochastic alpha, beta, rho model, a 3/2 model or a Chen model.

16. The one or more non-transitory computer-readable media of claim 9, wherein at least a portion of the market values are values of analogous financial interests, each of the analogous financial interests being different from an instance of the optioned transaction type

17. A computer system comprising:
at least one processor; and
at least one non-transitory memory, wherein the at least one non-transitory memory stores instructions that, when executed, cause the computer system to perform operations that include
accessing market value data, wherein (i) the market value data corresponds to an optioned transaction type and includes multiple market values, (ii) each of the market values corresponds to a value for an instance of the optioned transaction type at a different one of multiple times, and (iii) the multiple times are distributed throughout a first time period,
determining a volatility value based on the market values, wherein the volatility value quantifies a change in the market values applicable to a second time period,
calculating an option strike price listing range using the volatility value, and
storing option class definition data, wherein (i) the option class definition data defines a plurality of option classes, (ii) each of the option classes corresponds to the optioned transaction type and one of multiple strike prices, and (iii) each of the strike prices is a different price in the option strike price listing range.

18. The computer system of claim 17, wherein the stored instructions further comprise instructions that, when executed, cause the computer system to perform operations that include transmitting data identifying the option classes.

19. The computer system of claim 17, wherein the stored instructions further comprise instructions that, when executed, cause the computer system to perform operations that include
receiving order data corresponding to buy orders and sell orders for options corresponding to one of the option classes,
matching buy orders to sell orders, and
transmitting data indicating execution of options corresponding to the matched buy orders and sell orders.

20. The computer system of claim 17, wherein determining a volatility comprises determining a standard deviation applied to the second time period.

21. The computer system of claim 17, wherein determining a volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N}}$$
and wherein d is an annualization factor representing a number of days in a trading year, t is a time during the first time period, N is the total number of market values, Pₜ is the market value corresponding to time t, and Pₜ₋₁ is the market value corresponding to time t−1.

22. The computer system of claim 17, wherein determining a volatility comprises determining a volatility according to a stochastic volatility model.

23. The computer system of claim 22, wherein the stochastic volatility model is one of generalized autoregressive conditional heteroskedasticity model, a Heston model, a constant elasticity of variance model, a stochastic alpha, beta, rho model, a 3/2 model or a Chen model.

24. The computer system of claim 17, wherein at least a portion of the market values are values of analogous financial interests, each of the analogous financial interests being different from an instance of the optioned transaction type
